(19) United States
(12) Patent Application Publication
(10) Pub. No.: US 2005/0102424 A1
(43) Pub. Date: May 12, 2005

(54) Method for secure access of a WLAN-enabled terminal in a data network and device for carrying out said method

(75) Inventors: Uwe Foll, Falkensee (DE); Gerald Gormer, Basdorf (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/950,681

(22) Filed: Sep. 28, 2004

(30) Foreign Application Priority Data
Sep. 29, 2003 (DE) 103 45217.6

(51) Int. Cl. H04B 1/06

(52) U.S. Cl. 709/240

(57) ABSTRACT

A terminal is assigned to a home radio access network and the access node of the data network is assigned to a second radio access network. An access control function of the access node receives from the terminal a first message containing an authentication code. The access control function of the access node identifies the home radio access network associated with the terminal from the authentication code. The access control function then sends an inquiry message including the authentication code to an access control function of the home radio access network associated with the terminal. From the authentication code, the home radio access network identifies the user as a subscriber of the relevant home radio access network. This is done e.g. by interrogating data from the HLR (Home Location Register) or the HSS (Home Subscriber Server).

### CLAIM FOR PRIORITY

This application claims the benefit of priority to German Application No. DE 10345217.6, filed on Sep. 29, 2003, the contents of which are hereby incorporated by reference in its entirety.

### TECHNICAL FIELD OF THE INVENTION

The invention relates to a method for secure access of a WLAN-enabled terminal to a data network and to a device for secure access of a WLAN-enabled terminal to a data network.

### BACKGROUND OF THE INVENTION

WLAN (Wireless Local Area Network) has been developed alongside GSM, GPRS and UMTS as an additional mobile access option for a data network of a mobile service provider, such as the Internet or corporate data networks. For these wireless transmission networks several standards have just been defined by IEEE, the American Institute of Electrical and Electronic Engineers. These standards can be found under IEEE 802.11 ff., the best-known being 802.11a und 802.11b.

These WLANs are generally used in particular for closed user groups, constituting an alternative to infrared-connected networks or Bluetooth networks. In the closed groups this is advantageous as it enables cabling to be eliminated, and the user can choose any location as his workplace.

Recently public accesses via WLAN have also been provided. Entry is via a so-called hotspot generally belonging to a particular radio access network operator. These hotspots are situated in busy locations such as hotels, airports or even railroad stations. Thus, for example, business travelers can retrieve their electronic mail from the office in their absence, surf the Internet or similar.

However, the number of hotspots available is currently still relatively low, as two problems in particular emerge. On the one hand, the WLAN user must authenticate himself outside a closed user group. In addition, the user must also enable charging on the basis of the authentication. The WLANs and hotspots currently available are, because of their newness, either free or a flat rate payment is calculated which is charged to customer e.g. staying in a hotel on his hotel bill, similarly to the pay-per-view TV channels.

Clear user identification and proper charging, as well as, if necessary, encryption of data traffic are required. This becomes clear if one considers the average user who not only surfs the Internet but also retrieves business communications or prepares presentations as well as customer data which must of course be kept confidential.

Radio access network operators worldwide already have experience in the technologies of user identification and encryption as well as call charging. However, in addition to the established radio access network operators, a large number of independent network operators also offer dial-up access points, the so-called “hotspots”. However, it is currently unresolved as to how the independent WLAN operators can interwork with the existing radio access network networks. In addition to not having contractual relationships with the customers, the WLAN operator is also faced with the problem of setting up a cost-intensive call charge accounting infrastructure.

For the established radio access network operators, there is the problem of integrating the small local WLAN cell networks at all important locations, e.g. airports, railroad stations, etc., into the existing radio access network and thereby allowing its subscriber full-scale use.

FIG. 2 illustrates how a WLAN can be integrated with a GSM radio access network. Here the described advantages of the GSM network are already taken over for the WLAN.

The user with his mobile station (MS) can dial into a radio access network (RAN) where the normal infrastructure with databases, such as the Home Location Register (HLR) and Authentication Center (AUC), is available. In addition, the network contains an operating and maintenance unit responsible for user management, call charge accounting (billing system) and network management (mobile communications, WLAN).

The WLAN hotspot is connected to the radio access network via suitable interface computers (so-called gateways). The RADIUS server should first be mentioned which constitutes the interface for all user data.

There is additionally a billing interface (BGW, Billing Gateway).

The subscriber now obtains access to an ISP (Internet Service Provider) via the WLAN hotspot. However, all charging and subscriber information passes via his normal radio access network to which the relevant hotspot belongs.

The principle is described in the article “UMTS und WLAN werden einander ergänzen” (UMTS and WLAN will complement one another), Cornelius Boylan, NTZ edition 4 of 2002, page 20 et seq.

The overall requirement is that the WLAN hotspot is assigned to the user's corresponding GSM radio access network.

### SUMMARY OF THE INVENTION

The discloses a solution whereby even independent WLAN operators can interoperate with the existing radio access networks. The aspect of authentication of the potential service user at the hotspot is of particular interest here.

The invention also allows call charging for the services provided.

In one embodiment of the invention, there is a method for secure access of a WLAN-enabled terminal to a data network, wherein the terminal is assigned to a home radio access network and the access node of the data network is assigned to a second different network by the home radio access network. An access control function of the access node receives from the terminal a first message with an authentication code. The access control function of the access node identifies, on the basis of the authentication code, the home radio access network assigned to the terminal.

The access control function then sends an inquiry message including the authentication code to an access control function of the home radio access network associated with the terminal. On the basis of the authentication code, the home radio access network identifies the user as a subscriber of the relevant home radio access network. This is done, for example, by interrogating data from the HLR (Home Location Register) or the HSS (Home Subscriber Server).

Provided the subscriber is identified as “known”, the access control function notifies this to the access control function of the access node (hotspot). The access node (hotspot) then allows the subscriber to access the required network.

The device according to the invention for secure access of a WLAN-enabled terminal (MS) to a data network includes a device for receiving access requests of a WLAN-enabled terminal (MS) to a data network (INET). The device additionally includes a suitable interface (GW, Gateway) to the data network (INET). The received access request is then evaluated using means of access control (ZKF1). Evaluation of the access request produces a user authentication code on the basis of which the home radio access network (MNO1) associated with the terminal (MS) is then identified. The device additionally contains means for sending an inquiry message to the home radio access network (MNO1), the inquiry message including the user's authentication code. This inquiry message is sent to a second access control function (ZKF) of the first radio access network (MNO1) associated with the terminal. The device additionally contains means for processing and forwarding call charge data (GF).

The authentication code advantageously includes an identifier uniquely assigned to the terminal. This can be, for example, the MSISDN (mobile station ISDN number). The MSISDN is the technical designation for the network-specific number of the customer within a digital radio access network. This can be e.g. the customer's directory number. This MSISDN is unique. On the basis of the MSISDN it is easy for the access control function to identify the home radio access network associated with the user. The advantage for the subscriber is that he requires no further data other than his MSISDN which is known anyway.

After sending out the access request to the access node (hotspot), the subscriber advantageously sends a second message to his home radio access network. This further message increases the secure identification of the terminal and helps to confirm assumption of the resulting charges. On being received, a positive acknowledgment of this kind can also be forwarded to the access control function of the access node (hotspot). Secure authentication therefore takes place using any mobile communications technology.

In another embodiment of the invention, a charging function is instructed by the access node's access control function to collect call charge information during the connection established via it to the data network. This call charge information is transmitted to the user's home radio access network by the charging function or the access control function.

The call charge information contains identification information about the WLAN operator who has provided the access. In addition, this call charge information contains details of the call, e.g. the duration or the volume of data transmitted.

The user is then charged for the data services used by him via the home network operator's normal billing. The WLAN operator then receives a portion of the calculated charges from the subscriber's home network operator.

Further advantages of the invention flow from this. The WLAN operator requires no contractual relationship with the service user. This contractual relationship already exists between the service user and his home radio access network operator. It therefore suffices for the WLAN operator to have a contractual relationship with the relevant home network operators of the service user.

As call charge accounting is performed by the service user's home network operator, the WLAN operator also requires no additional infrastructure. This is of particular interest to smaller WLAN operators which provide their services locally.

One advantage for the service user is that these accrued charges for the data services can be invoiced via his usual mobile bill. He therefore has one bill to pay. In addition, he can be more flexible in choosing his service packages. He is not dependent on his own home radio access network operator's access node, but can use other access nodes (hotspots) of service providers who have an agreement with his home network operator.

There are also many advantages for the home network operator. He does not need to set up a global WLAN network but can offer a WLAN service to his subscribers by means of cooperations by concluding agreements with local WLAN service providers. Such agreements mean that he can nevertheless get part of the sales generated by the service. In addition, he receives statistical data about the usage behavior of his subscribers particularly through the billing data and can evaluate this for further services.

### BRIEF DESCRIPTION OF THE DRAWINGS

The invention will now be described with reference to the exemplary embodiments as illustrated in the drawings, in which:

FIG. 1 shows an exemplary implementation of the invention based on a 3GPP WLAN architecture.

FIG. 2 shows the prior art according to the article cited in the introduction.

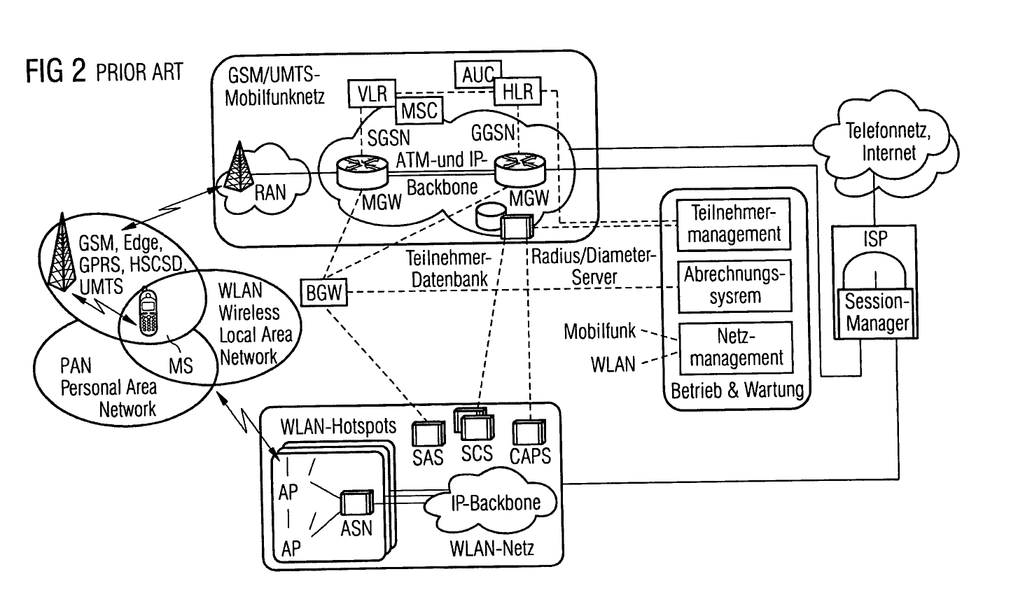

### DETAILED DESCRIPTION OF THE INVENTION

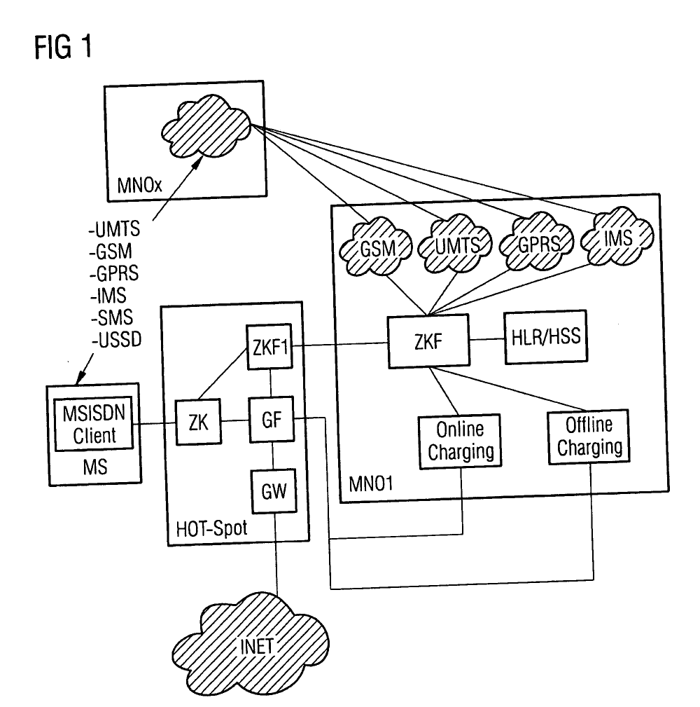

FIG. 1 shows two radio access network operators. The WLAN hotspot is run by a first operator (MNOx). However, the subscriber (MS) wishing to use the service is normally a user of his home radio access network (MNO1). The subscriber now wishes to log on to the WLAN hotspot, but there is no contractual relationship between the subscriber and the hotspot operator. However, the hotspot operator has concluded an agreement with the user's home network operator (MNO1).

For authentication at the WLAN access node (ZK), the subscriber gives e.g. his MSISDN as user name. A password is not necessary in this case. The access node (ZK) informs the access control function (ZKF1) about the subscriber's inquiry. The access control function can identify the subscriber's home network (MNO1) from the MSISDN. It sends an inquiry message containing the subscriber's MSISDN and also an identifier of the WLAN operator (MNOX) to an access control function (ZKF) in the subscriber's particular home network.

The access control function (ZKF) can obtain further information about the subscriber from its databases (HLR, HSS) and then allow the subscriber access via any radio access network (GSM, UMTS, GPRS, IMS) and any technology (SMS, USSD, SIP, . . . ), the subscriber's terminal (MS) possibly being registered with any radio access network, as is often the case with roaming. The network can be run by any operator.

The subscriber sends a positive acknowledgment to his home network. This procedure enables the subscriber to be securely identified by the WLAN. In addition, the subscriber confirms via a secure path that he will assume the charges for access. It is already known that in the case of access requests to a hotspot the call charge information is communicated in advance to the subscriber so that he can decide whether he wishes to use the access.

The positive acknowledgment is then communicated to the access node's access control function (ZKF1) which grants the subscriber access to its packet network (INIT) via a suitable interface (GW).

The access control function additionally instructs a charging function (GF) to collect call charge data such as the connection time or the call volume transmitted. The collected call charge data is then transmitted to the charging functions in the subscriber's home network either directly by the call charge function or via the access control function (ZKF1) (online charging, offline charging).

The call charge data includes, among other things, the usage time, the volume transmitted, and the WLAN operator's identifier. The charges accrued are billed to the subscriber by his home network operator. The WLAN operator obtains his charges from the subscriber's home network operator.

1. A method for secure access of a WLAN-enabled terminal to a data network, comprising:
assigning the terminal to a home radio access network;
assigning an access node of the data network to a second network;
receiving a first message including an authentication code via a first access control function of the access node from the terminal;
identifying, via the access control function of the access node based on the authentication code, the home radio access network assigned to the terminal;
sending, via the access control function, an inquiry message including the authentication code to a second access control function of the home radio access network associated with the terminal; and
enabling, after successful authentication, the terminal to access the WLAN network.

2. The method according to claim 1, wherein the authentication code is a unique identifier assigned to the terminal.

3. The Method according to claim 1, wherein a second message of the terminal is received by the home radio access network and is used for secure identification of the terminal and for confirmation of assumption of the resulting charges, and the confirmation is communicated to the access control function of the access node.

4. The method according to claim 1, wherein the access control function of the access node instructs a charging function to collect call charge information, and
The call charge information is transmitted to the home radio access network by the call charge function or by the access control function.

5. The method according to claim 4, wherein the call charge information includes identification information about the second network and information about the connection time and/or the volume of data transmitted during the call.

6. The method according to claim 4, wherein the second network performs a call charge calculation based on the call charge information which it receives for the call from the home radio access network; and
the home radio access network performs, based on the call charge information received, a call charge calculation of the call for the identified terminal.

7. A device for secure access of a WLAN-enabled terminal to a data network, comprising:
a receiving device for receiving access requests of a WLAN-enabled terminal to a data network, with a suitable interface to the data network;
an access device for access control which includes an identification device for identifying the home radio access network associated with the terminal based on the authentication code and a transmitting device for transmitting an inquiry message including the authentication code to a second access control function of the first radio access network associated with the terminal; and
a processing device for processing and forwarding call charge data.
